(19) United States
(12) Patent Application Publication
(10) Pub. No.: US 2003/0034324 A1
(43) Pub. Date: Feb. 20, 2003

(54) Method of manufacturing magnetoresistive device, thin film magnetic head and head assembly

(75) Inventors: Kunihiro Ueda, Chuo-ku (JP); Tetsuya Kuwashima, Chuo-ku (JP); Shunji Saruki, Chuo-ku (JP)

Correspondence Address: OLIFF & BERRIDGE, PLC, P.O. BOX 19928, ALEXANDRIA, VA, 22320, US

(73) Assignee: TDK CORPORATION, Chuo-ku (JP)

(21) Appl. No.: 09/923,447

(22) Filed: Aug. 8, 2001

(51) Int. Cl. B44C 1/22

(52) U.S. Cl. 216/22

(57) ABSTRACT

According to the present invention, a reproducing head having an MR film is formed on a substrate (step S102) and a recording head is formed (step S103). The MR film is formed by sequentially forming an antiferromagnetic layer, a first ferromagnetic layer, a tunnel barrier layer, and a second ferromagnetic layer. Subsequently, the end face perpendicular to an extending surface of the MR film is subjected to mechanical polishing to adjust the element height (step S105). The mechanically polished face is subjected to wet etching to remove residues of the mechanical polishing (step S106). Consequently, an electric short circuit in a tunnel barrier layer caused by residues at the time of polishing can be prevented, damage to the tunnel barrier layer and the recording head caused by the etching can be reduced, and a step in the substrate, the reproducing head, and the recording head can be made smaller as compared with the case of dry etching.

### BACKGROUND OF THE INVENTION

1. Field of the Invention

The present invention relates to a method of manufacturing a magnetoresistive device, a method of manufacturing a thin film magnetic head, and a method of manufacturing a head assembly, each including a process of polishing an end face of a magnetoresistive film perpendicular to an extending surface thereof.

2. Description of the Related Art

In recent years, improvement in performance of a thin film magnetic head is demanded in association with improvement in surface recording density of a hard disk or the like. As a thin film magnetic head, a composite thin film magnetic head in which a reproducing head having a magnetoresistive (MR) element and a recording head having an inductive magnetic transducer are laminated is widely used.

MR elements include an anisotropic magnetoresistive (AMR) element using a magnetic film (AMR film) displaying the AMR effect and a giant magnetoresistive (GMR) element using a magnetic film (GMR film) displaying the GMR effect. The GMR element is used for a reproducing head having a surface recording density which is higher than 3 Gbits/inch². GMR films of “multilayer type (antiferromagnetic type)”, “inductive ferrimagnetic type”, “granular type”, “spin valve type”, “tunnel junction type”, and the like are proposed.

Among the films, the GMR film of the spin valve type is widely practically used. In recent years, development of the GMR film of the tunnel junction type capable of obtaining a higher rate of change in magnetic resistance is advancing. The GMR film of the tunnel junction type has a tunnel barrier layer which is an extremely thin insulating layer between two ferromagnetic layers. When the direction of magnetization between the two ferromagnetic layers changes according to a signal magnetic field, a tunnel current flowing in the tunnel barrier layer changes.

A GMR element using such a GMR film of the tunnel junction type has what is called a CPP (Current Perpendicular to the Plane) structure in which a film forming plane of a GMR film is perpendicular to an air bearing surface (ABS) facing a recording medium such as a hard disk and a current is passed perpendicular to the film forming plane. When the air bearing surface is processed by mechanical polishing conventionally performed, there is consequently a case such that fine metal residues from a metal layer such as a ferromagnetic layer at the time of polishing remains on an end face of a tunnel barrier layer, an electric short circuit occurs in the tunnel barrier layer, and the characteristics of the element cannot be displayed. Mechanical polishing of the air bearing surface is very important since it determines how long the element is left in the perpendicular direction from the air bearing surface, that is, the length of the element in the direction perpendicular to the air bearing surface (hereinbelow, called element height), so that the mechanical polishing cannot be omitted. Conventionally, the air bearing surface is mechanically polished and, after that, residues of the mechanical polishing are removed by dry etching, ion milling, or the like (disclosed in Japanese Unexamined Patent Application Publication No. 11-175927 and the like).

However, the conventional technique of processing the air bearing surface by a beam technology in a broad sense such as dry etching or ion milling has problems described hereinbelow. First, due to injection of charged or not-charged particles having energy into the tunnel barrier layer, damage occurs and the film characteristics deteriorate.

Second, since steam pressure of a halogen compound as a magnetic material is generally high, it is difficult to perform chemical etching. In the conventional method, physical etching is therefore mainly performed irrespective of the kind of gas used. Consequently, the etching rate (milling rate) varies according to materials. When etching sufficient to remove the residues of mechanical polishing is performed, a step occurs in the air bearing surface due to the variations in the etching rate. Particularly, in the composite thin film magnetic head in which the reproducing head and the recording head are laminated on a base, the reproducing head and the recording head are etched easier than the base. The recording head is etched easier than the reproducing head. The distance between the reproducing and recording head and a recording medium cannot be therefore shortened, and an output cannot be increased.

### SUMMARY OF THE INVENTION

An object of the invention is to provide a method of manufacturing a magnetoresistive device, a method of manufacturing a thin film magnetic head, and a method of manufacturing a head assembly, each capable of improving characteristics.

A method of manufacturing a magnetoresistive device according to the invention comprises steps of: forming a magnetoresistive film on a base; and mechanically polishing an end face of the magnetoresistive film, and performing wet etching on the end face mechanically polished.

A method of manufacturing a thin film magnetic head according to the invention comprises steps of: forming a reproducing head having a magnetoresistive film on a base; and mechanically polishing an end face of the magnetoresistive film, and performing wet etching on the end face mechanically polished.

A method of manufacturing a head assembly according to the invention comprises steps of: forming a slider having a reproducing head; and mounting the slider on a slider suspension. The step of forming the slider comprises steps of forming a reproducing head having a magnetoresistive film on a base; and mechanically polishing an end face of the magnetoresistive film, and performing wet etching on the end face mechanically polished.

In the method of manufacturing a magnetoresistive device, a method of manufacturing a thin film magnetic head, and a method of manufacturing a head assembly according to the invention, the end face perpendicular to the extending surface of the magnetoresistive film is mechanically polished and, after that, residues of the mechanical polishing are removed by the wet etching. Thus, damage to the magnetoresistive film is reduced, and a step between the base and the magnetoresistive film is small in comparison with the case of performing dry etching. Preferably, an etchant containing at least one of acid and alkali is used in the wet etching process.

The step of forming the magnetoresistive film may include a step of forming a first ferromagnetic layer, a tunnel barrier layer, and a second ferromagnetic layer in order on the base. Further, a step of forming a current path for passing a current in a direction perpendicular to an extending surface of the magnetoresistive film may be included.

In addition, each of the method of manufacturing the thin film magnetic head and the method of manufacturing the head assembly may comprise a step of forming a recording head on the base before the step of mechanically polishing the end face.

Other and further objects, features and advantages of the invention will appear more fully from the following description.

### BRIEF DESCRIPTION OF THE DRAWINGS

FIG. 1 is a perspective view showing the configuration of a head assembly manufactured by a method of manufacturing a head assembly according to an embodiment of the invention.

FIG. 2 is a flowchart showing the processes of the method of manufacturing a head assembly according to the embodiment of the invention.

FIG. 3 is a cross section showing a process in the method of manufacturing the head assembly illustrated in FIG. 2.

FIGS. 4A and 4B are cross sections showing a process continued from FIG. 3.

FIG. 5 is a partially enlarged view of a multilayer film in FIG. 4A.

FIGS. 6A and 6B are cross sections showing a process continued from FIGS. 4A and 4B.

FIGS. 7A and 7B are cross sections showing a process continued from FIGS. 6A and 6B.

FIGS. 8A and 8B are cross sections showing a process continued from FIGS. 7A and 7B.

FIGS. 9A and 9B are cross sections showing a process continued from FIGS. 8A and 8B.

FIGS. 10A and 10B are cross sections showing a process continued from FIGS. 9A and 9B.

FIGS. 11A and 11B are cross sections showing a process continued from FIGS. 10A and 10B.

FIGS. 12A and 12B are cross sections showing a process continued from FIGS. 11A and 11B.

FIG. 13 is a cross section showing a process continued from FIG. 12A.

FIG. 14 is a perspective view showing a process continued from FIG. 13.

FIG. 15 is a partially exploded perspective view showing an enlarged part of FIG. 14.

FIGS. 16A and 16B are cross sections showing a modification of the method of manufacturing the head assembly according to the embodiment of the invention.

FIGS. 17A and 17B are cross sections showing a process continued from FIGS. 16A and 16B.

FIGS. 18A and 18B are cross sections showing a process continued from FIGS. 17A and 17B.

FIGS. 19A and 19B are cross sections showing a process continued from FIGS. 18A and 18B.

### DETAILED DESCRIPTION OF THE PRFERRED EMBODIMENTS

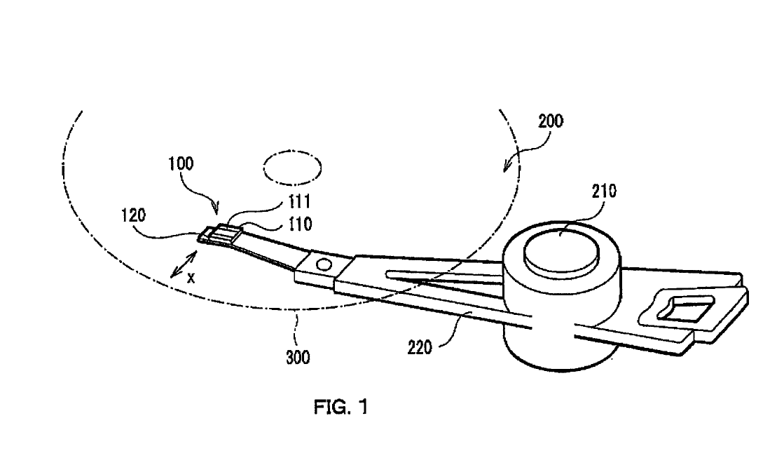

Embodiments of the invention will now be described in detail hereinbelow with reference to the drawings. In the following embodiment, a case of manufacturing a head assembly having a configuration as shown in FIG. 1 will be described as an example. The head assembly is used for, for example, a not-illustrated hard disk drive or the like, and has a slider 100 in which a thin magnetic head 120 is formed on a base 110 and a slider suspension 200 on which the slider 100 is mounted. The slider suspension 200 has an arm 220 swingably supported by a spindle 210. The slider 100 moves in the direction x crossing track lines along the recording surface of a recording medium 300 such as a hard disk by the swing of the arm 220. The surface facing the recording surface of the recording medium 300, of the slider 100 is called an air bearing surface. The thin film magnetic head 120 is formed on a surface perpendicular to an air bearing surface 111 of the base 110.

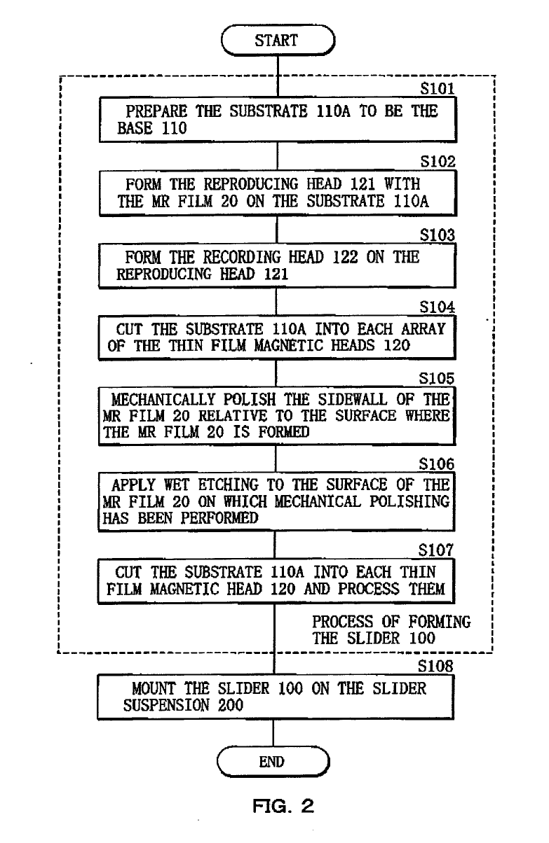

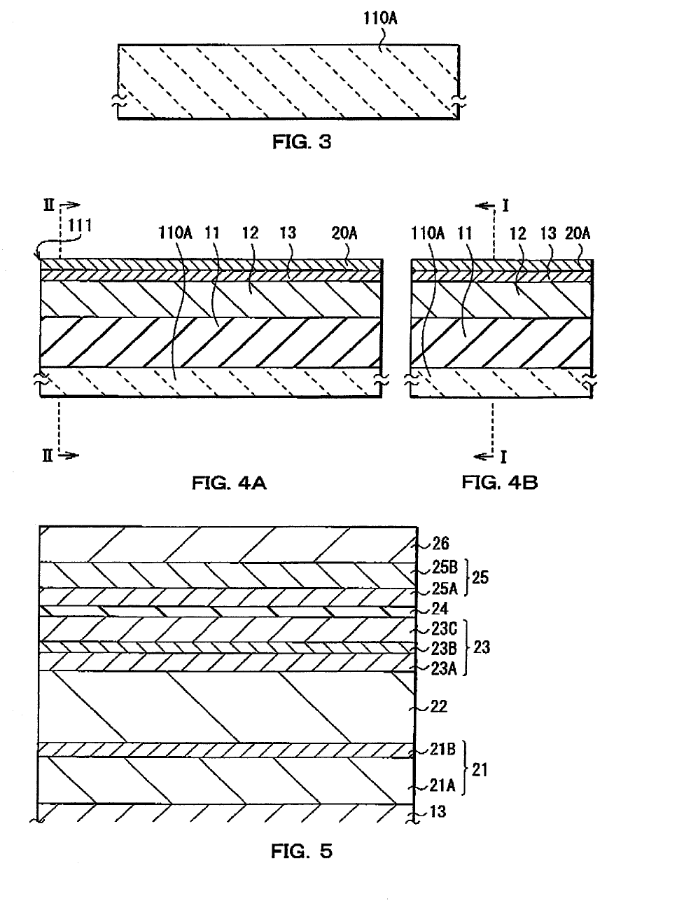

FIG. 2 shows the flow of processes in the method of manufacturing the head assembly according to the embodiment of the invention. Each of FIGS. 3 to 15 shows the structure in each of the processes in the method of manufacturing the head assembly illustrated in FIG. 2. Since a method of manufacturing an MR element and a method of manufacturing a thin film magnetic head according to an embodiment of the invention are embodied in the method of manufacturing the head assembly according to the embodiment, they will be also described hereinbelow.

First, as shown in FIG. 3, a substrate 110A made of a composite material of, for example, aluminum oxide (Al₂O₃) and titanium carbide (TiC) is prepared (step S100). The substrate 110A finally becomes the base 110 and has a plurality of base formation areas.

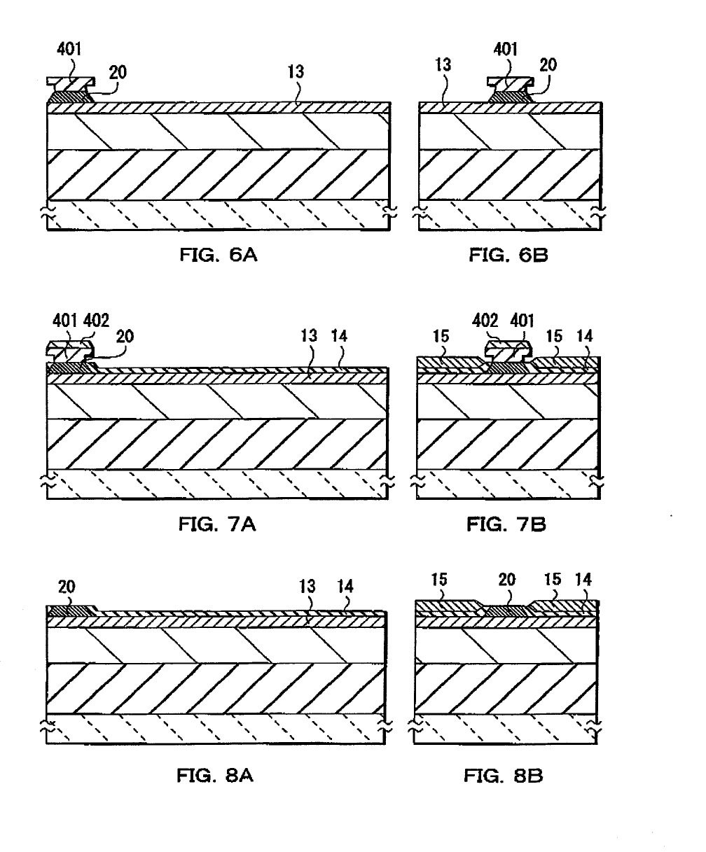

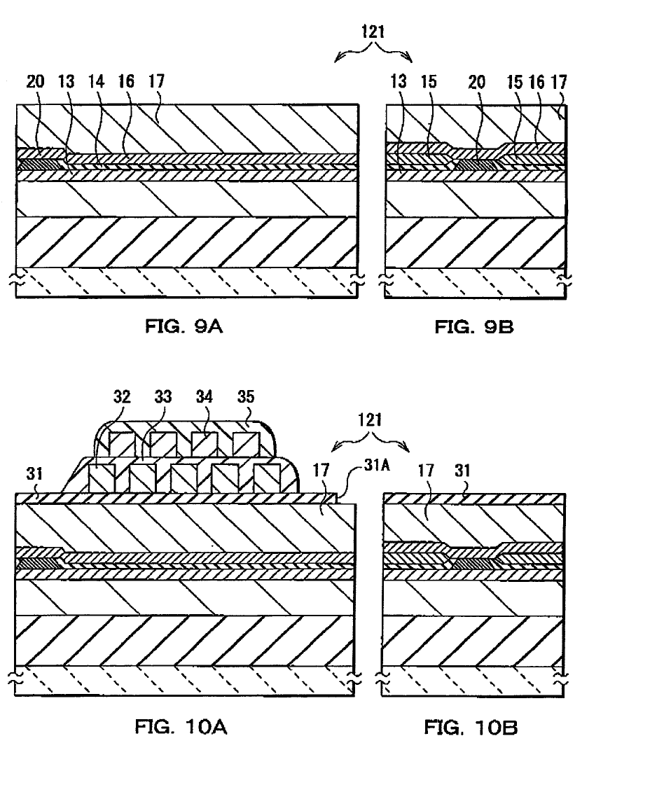

Subsequently, on the substrate 110A, a reproducing head 121 (refer to FIGS. 9A and 9B) is formed (step S102). Concretely, as shown in FIGS. 4A and 4B, first, an undercoat layer 11 made of an insulating material such as aluminum oxide and having a thickness in the laminate direction (hereinbelow, simply called thickness) of 5 μm is formed by, for example, sputtering. FIG. 4A is a cross section in the element laminate direction perpendicular to the air bearing surface (ABS) 111, and FIG. 4B is a cross section in the element laminate direction parallel to the air bearing surface 111. FIG. 4A shows a part on the side of the air bearing surface 111 along the I-I line of FIG. 4B. FIG. 4B shows a part around the II line along the II-II line of FIG. 4A. The indication is similar to those of FIGS. 6A and 6B to FIGS. 12A and 12B. In FIGS. 6A and 6B to FIGS. 12A and 12B, the indications of the I-I line and the II-II line are omitted.

Subsequently, on the undercoat layer 11, a first shield layer 12 made of a magnetic material such as a nickel iron alloy (NiFe alloy) and having a thickness of 2 μm is formed by, for example, plating. The first shield layer 12 is provided to prevent an influence of an unnecessary magnetic field from being exerted on an MR film 20 which will be described hereinlater. On the first shield layer 12, a first gap layer 13 made of a conductive non-magnetic material such as tantalum (Ta) and having a thickness of 0.01 μm is formed by, for example, sputtering. The first gap layer 13 is to interrupt magnetic coupling between the first shield layer 12 and the MR film 20 which will be described hereinlater. The first gap layer 13 and the first shield layer 12 function as a current path for passing a current in the direction perpendicular to the film forming plane of the MR film 20. On the first gap layer 13, a multilayer film 20A to become the MR film 20 (refer to FIGS. 6A and 6B) is formed.

The multilayer film 20A is, as shown in FIG. 5, formed as follows. FIG. 5 shows an enlarged part of FIG. 4A. First, on the first gap layer 13, a tantalum layer 21A having a thickness of 10 nm and an NiFe alloy layer 21B having a thickness of 2 nm are laminated in this order by, for example, sputtering, thereby forming an under layer 21. Subsequently, on the under layer 21, an antiferromagnetic layer 22 made of an antiferromagnetic material such as a platinum manganese alloy (PtMn alloy) and having a thickness of 15 nm is formed by, for example, sputtering.

Subsequently, on the antiferromagnetic layer 22, a magnetic layer 23A having a thickness of 2 nm and made of a magnetic material such as a cobalt-iron alloy (CoFe alloy), a non-magnetic layer 23B having a thickness of 1 nm and made of a conductive non-magnetic material such as ruthenium, and a magnetic layer 23C having a thickness of 3 nm and made of a magnetic material such as a CoFe alloy are laminated in this order, thereby forming a first ferromagnetic layer 23. Since the direction of magnetization of the first ferromagnetic layer 23 is fixed by exchange coupling in the interface with the antiferromagnetic layer 22, the first ferromagnetic layer 23 is also called a pinned layer. The non-magnetic layer 23B causes antiferromagnetic exchange coupling between the magnetic layers 23A and 23C to make the directions of magnetization of the magnetic layers 23A and 23C opposite to each other, thereby reducing an influence of the magnetic field generated by the first ferromagnetic layer 23 exerted on a second ferromagnetic layer which will be described hereinlater.

After forming the first ferromagnetic layer 23, on the first ferromagnetic layer 23, a metal film made of aluminum (Al) or the like is formed by, for example, sputtering. The metal film is oxidized by heating treatment, thereby forming a tunnel barrier layer 24 made of an insulating material such as a compound of aluminum and oxygen and having a thickness of about 1 nm. After forming the tunnel barrier layer 24, on the tunnel barrier layer 24, a magnetic layer 25A having a thickness of 2 nm and made of a magnetic material such as a CoFe alloy and a magnetic layer 25B having a thickness of 3 nm and made of a magnetic material such as an NiFe alloy are laminated in this order, thereby forming a second ferromagnetic layer 25. Since the direction of magnetization of the second ferromagnetic layer 25 changes according to a signal magnetic field from the recording medium 300, the second ferromagnetic layer 25 is also called a free layer. After that, on the second ferromagnetic layer 25, a cap layer 26 made of tantalum or the like and having a thickness of 5 nm is formed by, for example, sputtering. In such a manner, the multilayer film 20A is formed.

After forming the multilayer film 20A, as shown in FIGS. 6A and 6B, for example, on the multilayer film 20A, a photoresist film 401 is selectively formed in correspondence with an area for forming the MR film 20. The sectional shape of the photoresist film 401 is, preferably, a T shape obtained by forming a groove in the interface with the multilayer film 20A so that a lift-off process which will be described hereinlater can be easily performed. After forming the photoresist film 401, by using the photoresist film 401 as a mask, the multilayer film 20A is selectively etched by, for example, ion milling, thereby forming the MR film 20 of the tunnel junction type.

After forming the MR film 20, as shown in FIGS. 7A and 7B, on the first gap layer 13, an insulating layer 14 made of aluminum oxide or the like is formed by, for example, sputtering. The insulating layer 14 is to provide electrical insulation between the first gap layer 13 and a second gap layer 16 (refer to FIGS. 9A and 9B) which will be described hereinlater. After that, on the insulating layer 14 corresponding to both sides of the MR film 20, a magnetic domain control layer 15 made of a hard magnetic material such as a cobalt-platinum alloy (CoPt alloy) and having a thickness of 20 nm is selectively formed by, for example, sputtering. The magnetic domain control layer 15 is used to adjust the direction of magnetization of the second ferromagnetic layer 25 to suppress occurrence of what is called Barkhausen noise. Alternately, the magnetic domain control layer 15 may be formed by laminating a ferromagnetic layer and an antiferromagnetic layer.

After forming the magnetic domain control layer 15, as shown in FIGS. 8A and 8B, the photoresist film 401 is removed together with a deposit 402 on the photoresist film 401 by, for example, a lift-off process. After that, as shown in FIGS. 9A and 9B, the second gap layer 16 made of a conductive non-magnetic material such as tantalum and having a thickness of 0.03 μm is formed by, for example, sputtering so as to cover the first gap layer 13, MR film 20, and magnetic domain control layer 15. The second gap layer 16 is used to interrupt magnetic coupling between the MR film 20 and a second shield layer 17 which will be described hereinlater. The second gap layer 16 and the second shield layer 17 have the function of a current path for passing a current to the MR film 20 in the direction perpendicular to the extending surface of the MR film 20. After that, on the second gap layer 16, the second shield layer 17 made of a magnetic material such as a NiFe alloy and having a thickness of 4 μm is formed by, for example, plating. In a manner similar to the first shied layer 12, the second shield layer 17 is used to prevent the influence of an unnecessary magnetic field from being exerted on the MR film 20.

In such a manner, the MR device having the MR film 20 of the tunnel junction type, the magnetic domain control layer 15, and the current path for passing the current to the MR film 20 in the direction perpendicular thereto are formed, and a reproducing head 121 having the MR element are completed. The reproducing head 121 reads information recorded on the recording medium 300 by using the phenomenon that the angle of the directions of magnetization of the first and second ferromagnetic layers 23 and 25 changes according to the signal magnetic field from the recording medium 300 and the tunnel current flowing in the tunnel barrier layer 24 accordingly changes.

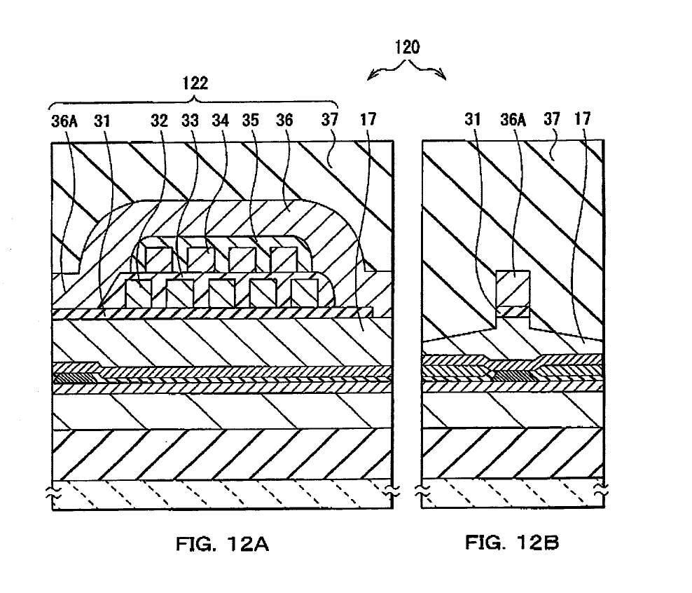

After forming the reproducing head 121, on the reproducing head 121, a recording head 122 (refer to FIGS. 12A and 12B) is formed (step S103). Concretely, first, as shown in FIGS. 10A and 10B, a recording gap layer 31 made of an insulating material such as aluminum oxide and having a thickness of 0.1 μm is formed on the second shield layer 17 by, for example, sputtering. The second shield layer 17 also functions as a bottom pole of the recording head 122. The recording gap layer 31 is partly etched to form an opening 31A for forming a magnetic path.

Subsequently, a thin film coil 32 is formed around the opening 31A as a center on the recording gap layer 31, and a photoresist layer 33 having a thickness of 1.8 μm which determines the throat height is formed in a predetermined pattern so as to cover the thin film coil 32. After that, on the photoresist layer 33, as necessary, a thin film coil 34 and a photoresist layer 35 are repeatedly formed. In the embodiment, the two thin film coils are laminated. The number of thin film coils laminated may be one or three or more.

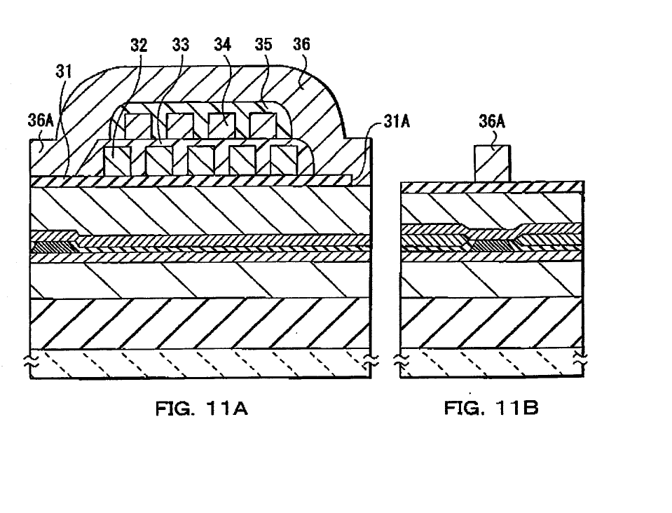

After forming the photoresist layer 35, as shown in FIG. 11, for example, on the recording gap layer 31, opening 31A, and photoresist layers 33 and 35, a top pole 36 made of a magnetic material having a high saturated magnetic flux density such as a NiFe alloy, iron nitride (FeN), or CoFe alloy and having a thickness of 2.5 μm is formed. The top pole 36 is in contact with and magnetically coupled to the second shield layer 17 via the opening 31A in the recording gap layer 31. An end portion on the air bearing surface 111 of the top pole 36 is a recording pole 36A. Preferably, the height (length in the laminate direction) of the recording pole 36A on the air bearing surface 111 is, for example, about 2.5 μm, and the width of the recording pole 36A in the air bearing surface 111 is, for example, about 0.2 μm.

After forming the top pole 36, for example, by using the top pole 36 as a mask, the recording gap layer 31 and the second shield layer 17 are selectively etched by ion milling. After that, as shown in FIGS. 12A and 12B, an overcoat layer 37 made of an insulating material such as aluminum oxide and having a thickness of 30 μm is formed on the top pole 36. In such a manner, the recording head 122 is formed, and the thin film magnetic head 120 having the reproducing head 121 and the recording head 122 is formed. The recording head 122 generates a magnetic flux between the second shield layer 17 as the bottom pole and the top pole 36 by the current flowing in the thin film coils 32 and 34, magnetizes the recording medium 300 by the magnetic flux generated near the recording gap layer 31, and records information.

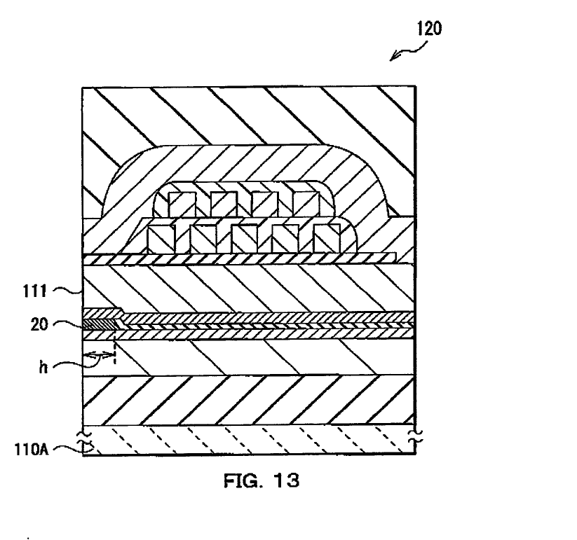

After forming the thin film magnetic head 120, the substrate 110A is cut into, for example, arrays of thin film magnetic heads 120 (step S104). As shown in FIG. 13, the air bearing surface 111 of the thin film magnetic head 120 is mechanically polished. Specifically, an end face of the MR film 20 is mechanically polished, thereby adjusting the element height h (step S105). The element height h is a factor of determining a reproduction output. The shorter the element height is, the higher the reproduction output is. However, when the element height is too short, the reproduction output decreases due to an increase in temperature, and the life becomes shorter. It is therefore preferable to make the element height h short to the extent that an adverse influence due to an increase in temperature is not exerted, for example, to about 0.2 μm. FIG. 13 shows a sectional structure in the same direction as FIG. 12A.

After performing mechanical polishing, the mechanically polished surface of the base 110 and the thin film magnetic head 120 is subjected to wet etching to remove residues of the mechanical polishing (step S106). With the configuration, an electric short circuit in the tunnel barrier layer 24 caused by residues in the polishing in the MR film 20 is prevented. In the embodiment, the residues of the mechanical polishing are removed by the wet etching. Consequently, damage to the MR film 20, particularly, the tunnel barrier layer 24 and damage to the recording pole 36A is reduced. Further, a step between the base 110 and the reproducing head 121/recording head 122 caused by etching is also suppressed.

It is preferable to use an etchant containing at least one of acid and alkali at the time of wet etching. The acid may be inorganic acid or organic acid. The alkali may be inorganic alkali or organic alkali. Preferable inorganic acids are, for example, hydrofluoric acid, nitric acid, hydrochloric acid, and phosphoric acid. Preferable organic acids are, for example, acetic acid, lactic acid, oxalic acid, citric acid, and tartaric acid. Preferable inorganic alkalis are, for example, potassium hydroxide and sodium hydroxide. A preferable organic alkali is, for example, a tetramethylammonium hydroxide (TMAH).

The etchants will be more concretely described. As examples, etchants shown in (1) to (9) in Table 1 can be mentioned.

TABLE 1
Kinds of Etchant

| | |
|---|---|
| (1) | mixture of hydrofluoric acid of 40% by volume: nitric acid |
| | solution of 69% by volume: acetic acid in a volume ratio |
| | of 20:50:5 |
| (2) | mixture of lactic acid: nitric acid solution of 68% by volume: |
| | hydrofluoric acid of 48% by volume in a volume ratio of 30:10:10 |
| (3) | mixture of TMAH solution of 3% by mass and sodium hydroxide of |
| | 3% by mass |
| (4) | solution of nitric acid and hydrofluoric acid |
| (5) | mixture of hydrochloric acid of 38% by volume: water in a volume |
| | ratio of 1:4 |
| (6) | solution of orthophosphoric acid of 18% by volume |
| (7) | mixed solution of nitric acid and sodium sulfate |
| (8) | mixed solution of potassium hydroxide and hydrogen peroxide |
| (9) | mixed solution of sodium hydroxide and hydrogen peroxide |

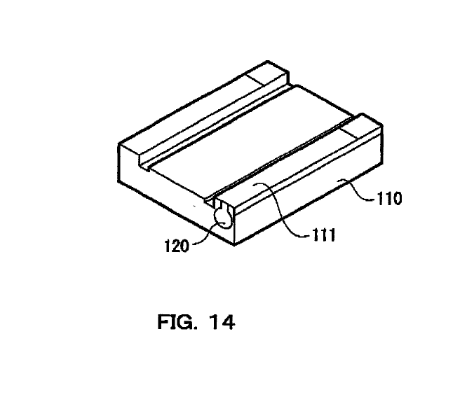

After performing the wet etching, as necessary, cleaning with pure water or cleaning with an organic solvent such as isopropyl alcohol is made, and acetone is sprayed and dried. After that, as shown in FIG. 14, the substrate 110A is cut into a plurality of blocks each having one thin film magnetic head 120 and having a predetermined shape of a rectangular parallelepiped (step S107). As enlargedly shown in FIG. 15, the slider 100 in which the thin film magnetic head 120 having the reproducing head 121 and the recording head 122 is provided on the base 110 is formed. That is, the MR device and the thin film magnetic head 120 are completed. FIG. 15 is an exploded view of the thin film magnetic head 120.

After forming the slider 100, the slider suspension 200 is prepared, and the slider 100 is mounted at the tip of the arm 220 so that the air bearing surface 111 faces upward (step S108). Finally, the head assembly shown in FIG. 1 is completed.

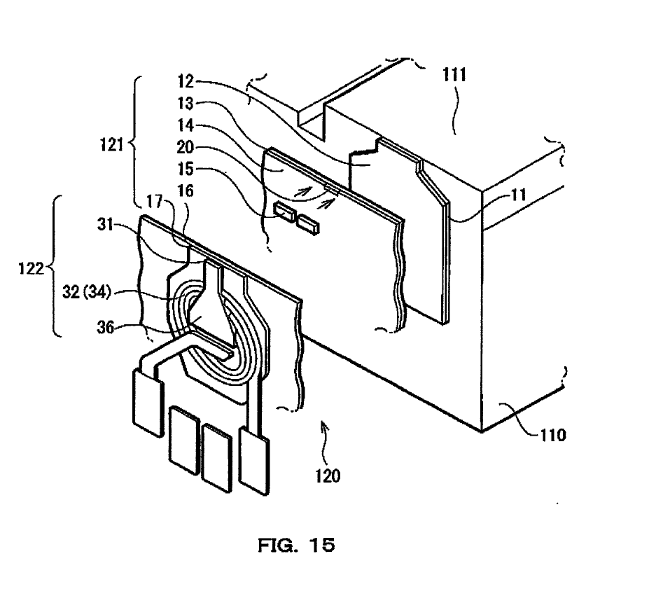

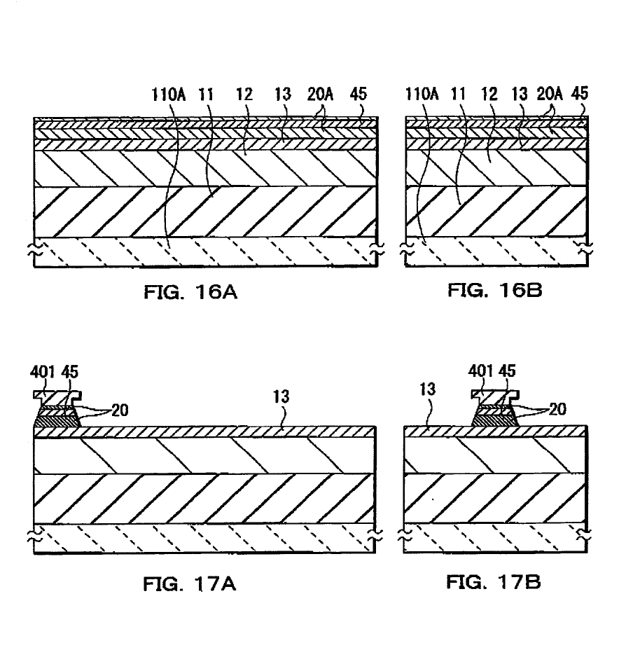

The process of forming the reproducing head 121 may be also performed as follows. FIGS. 16A and 16B to FIGS. 19A and 19B show another process of forming the reproducing head 121. FIGS. 16A and 16B to FIGS. 19A and 19B show the sectional structure similar to FIGS. 4A and 4B and indication of the line I-I shown in FIG. 4B and the line II-II in FIG. 4A are omitted.

First, in a manner similar to the above manufacturing method, the undercoat layer 11, first shield layer 12, and first gap layer 13 are formed on the substrate 110A (refer to FIGS. 4A and 4B). Subsequently, as shown in FIGS. 16A and 16B, in a manner similar to the above-described manufacturing method, the under layer 21, antiferromagnetic layer 22, first ferromagnetic layer 23, tunnel barrier layer 24, and second ferromagnetic layer 25 in the multilayer film 20A which becomes the MR film 20 are formed. On the second ferromagnetic layer 25, for example, by sputtering, a magnetic domain control layer 45 constructed by a layer made of a non-magnetic material such as ruthenium (Ru) or rhodium (Rh) and having a thickness of about 1 nm, and a layer made of an antiferromagnetic material such as a ruthenium-rhodium-manganese alloy (RuRhMn alloy) or iridium-manganese alloy (IrMn alloy) and having a thickness of about 10 nm is formed. As described in the manufacturing method, the magnetic domain control layer 45 may have a configuration in which a ferromagnetic layer and an antiferromagnetic layer are laminated.

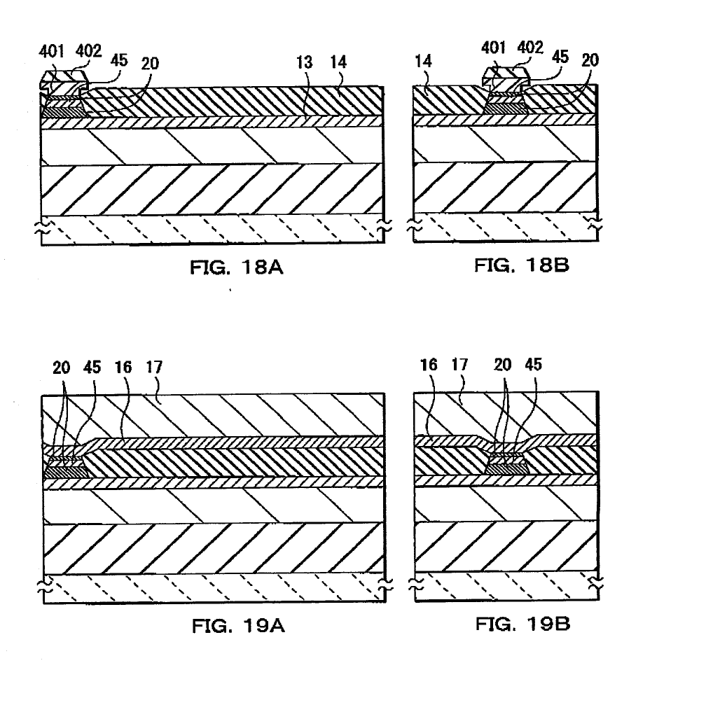

After forming the magnetic domain control layer 45, as shown in FIGS. 16A and 16B, on the magnetic domain control layer 45, the cap layer 26 in the multilayer film 20A is formed in a manner similar to the above manufacturing method. After that, as shown in FIGS. 17A and 17B, in a manner similar to the above manufacturing method, the photoresist film 401 is selectively formed in correspondence with the area for forming the MR film 20 on the cap layer 26, and the multilayer film 20A and the magnetic domain control layer 45 are selectively etched, thereby forming the MR film 20. After forming the MR film 20, as shown in FIGS. 18A and 18B, the insulating layer 14 is formed on the first gap layer 13 in a manner similar to the above manufacturing method. As shown in FIGS. 19A and 19B, in a manner similar to the above manufacturing method, the photoresist film 401 and the deposit 402 are removed, and the second gap layer 16 and the second shield layer 17 are formed, thereby forming the reproducing head 121.

Also in the case of forming the reproducing head 121 by such a process, by mechanically polishing the end face of the MR film 20 and removing the residues of the mechanical polishing by the wet etching in a manner similar to the above manufacturing method, damage to the MR film 20 is reduced and the step caused by the etching is suppressed.

According to the embodiment as described above, after mechanically polishing the end face of the MR film 20, the mechanically polished face is subjected to wet etching. Consequently, the residues of the mechanical polishing can be removed, and an electric short circuit which is caused in the tunnel barrier layer 24 by residues in the polishing process can be prevented. Thus, the improved characteristics can be achieved.

Since the wet etching is used, damage to the MR film 20, particularly, the tunnel barrier layer 24 can be reduced, and the reproduction characteristics can be improved. Further, damage to the recording pole 36A can be also reduced, and the recording characteristics can be also improved.

In addition, the step in the base 110, reproducing head 121, and recording head 122 caused by etching can be reduced. Particularly, since the area in the air bearing surface 111, of the recording pole 36A is large, the recording pole 36A is easily etched. However, according to the embodiment, the step can be reduced as compared with the case of performing dry etching. Consequently, the distance between the recording medium 300 and the recording pole 36A and the MR film 20 can be shortened as compared with the case of using dry etching. The recording characteristics can be improved and the reproducing characteristics can be also improved.

### EXAMPLES

Concrete examples of the invention will now be described in detail.

As Examples 1 to 3, the head assembly shown in FIG. 1 was fabricated in a manner similar to the embodiment. In Examples 1 to 3, different etchants for use in the process of performing wet etching on the mechanically polished face of the MR film 20 (step S106) were used. In Example 1, the etchant (1) shown in Table 1 was used. In Example 2, the etchant (2) shown in Table 1 was used. In Example 3, the etchant (3) in Table 1 was used. Except for the etchants, the same conditions were used for Examples 1 to 3.

Reproduced outputs of the head assemblies fabricated in Examples 1 to 3 were measured. Reproduced outputs were measured with respect to the case of reproducing the magnetic disk 300 on which a predetermined solitary wave was pre-recorded and a case of recording data onto the magnetic disk 300 by using the fabricated head assembly and reproducing the data. As the magnetic disk 300, a magnetic disk obtained by sequentially laminating an under layer made of chrome (Cr) and having a thickness of 10 nm, a magnetic layer made of a cobalt-chrome-platinum alloy (CoCrPt alloy) and having a thickness of 20 nm, a protective layer made of carbon and having a thickness of 10 nm, and a lubricant on a glass substrate was used. The magnetic disk 300 has magnetic field strength of about 29×10⁴ A/m (3600 Oe) and a product BrT of magnetic flux density and thickness of 0.01 Tμm. The flying height of the thin film magnetic head 120, that is, the distance between the air bearing surface 111 of the slider 100 and the protective layer of the magnetic disk 300 was set to 20 nm, and a sense current at the time of reproduction was set to 50 mA/μm². Further, in the case of performing self recording, a current of 45 mA was passed to the recording head 122.

The step in the air bearing surface 111 in the slider 100 of each of the fabricated head assemblies of Examples 1 to 3 was measured. An atomic force microscope (AFM) was used for the measurement, and the step was regarded as a difference between average height of the base 110 and average height of the thin film magnetic head 120 in the air bearing surface 111. The results are shown in Table 2.

TABLE 2

| | | Reproduction output (mV) | | |
|---|---|---|---|---|
| | | only | self-recording | step |
| | Etching condition | reproduction | & reproduction | (nm) |
| Example 1 | wet etching using | 3.5 | 3.6 | 1.5 |
| | etchant (1) | | | |
| Example 2 | wet etching using | 3.8 | 3.7 | 0.8 |
| | etchant (2) | | | |
| Example 3 | wet etching using | 4.0 | 4.1 | 1.0 |
| | etchant (3) | | | |
| Comparative | plasma etching | 2.9 | 1.1 | 10 |
| Example | | | | |

As a comparative example for the examples, a head assembly was fabricated under the same conditions as those of the examples except that the mechanically polished face of the MR film was subjected to plasma etching as a kind of dry etching in place of wet etching. With respect to the comparative example as well, the reproduced output was measured in a manner similar to the examples, and a step in the air bearing surface in the slider was measured. The results were also shown in Table 2.

As understood from Table 2, according to the embodiment, a larger reproduced output as compared with the comparative example could be obtained. In particular, in the case of performing self-recording and reproduction, it was very effective. The step in the air bearing surface 111 could be reduced by more than one digit as compared with the comparative example. It is therefore understood that when the end face of the MR film 20 is mechanically polished, and the end face mechanically polished is subjected to wet etching, the step in the air bearing surface 111 can be made smaller as compared with the case of the dry etching and a larger reproduction output can be obtained. It is considered that the improvement was achieved because the distance between the magnetic disk 300 and the recording pole 36A and the MR film 20 became shorter and damage to the MR film 20 and the recording pole 36A was reduced by performing the wet etching as compared with the dry etching.

In the examples, some examples of the etchants used for the process of performing the wet etching (step S106) have been concretely described. Similar effects can be obtained when other etchants are used.

Although the invention has been described by the embodiments and examples, the invention is not limited to the embodiments and examples but can be variously modified. For example, in the foregoing embodiments and examples, the case of forming the MR film 20 of the tunnel junction type by sequentially laminating the antiferromagnetic layer 22, first ferromagnetic layer 23, tunnel barrier layer 24, and second ferromagnetic layer 25 on the substrate 110A has been described. Alternately, the first ferromagnetic layer, tunnel barrier layer, second ferromagnetic layer, and antiferromagnetic layer may be sequentially laminated on the substrate 110A. In this case, the first ferromagnetic layer is a free layer in which the direction of magnetization changes according to the signal magnetic field, and the second ferromagnetic layer is a pinned layer in which the direction of magnetization is fixed by the antiferromagnetic layer.

In the foregoing embodiments and examples, the concrete example of the process of forming the MR film 20 of the tunnel junction type has been described. As long as the process of sequentially laminating the first ferromagnetic layer, tunnel barrier layer, and second ferromagnetic layer is included, the other process may not be included. A process other than those described in the foregoing embodiment may be further included.

Although the case of forming the MR film 20 of the tunnel junction type has been described in the embodiment and examples, the invention can be also similarly applied to the case of forming other MR films such as MR films of the multilayer type, inductive ferrimagnetic type, granular type, and spin valve type. In addition, the invention can be applied not only to the GMR films but also to the case of forming an AMR film. The invention is particularly effective in the case where a current is passed to the MR film in the direction perpendicular to the film forming plane and more particularly in the case where an electric short circuit in the tunnel barrier layer 24 is a problem as in the MR film 20 of the tunnel junction type described in the foregoing embodiment.

Further, in the embodiments and examples, the case including the process of forming the reproducing head 121 and the recording head 122 has been described. Only the process of forming the reproducing head 121 may be included and the process of forming the recording head may not be included. According to the invention, as described in the embodiments and examples, the case including both of the processes produces a higher effect. In the foregoing embodiments and examples, the case of forming the reproducing head 121 on the base 110 and then forming the recording head 122 has been described. It is also possible to form the recording head on the base 110 and, after that, form the reproducing head.

In addition, in the embodiments and examples, the process of manufacturing the thin film magnetic head 120 and the head assembly has been described by mentioning the concrete examples. As long as the process of forming the MR film and the process of mechanically polishing the end face of the MR film and performing wet etching are included, other processes may not be included, and further, processes other than the processes described above may be included.

Furthermore, the method of manufacturing the magnetoresistive device of the invention can be applied not only to the case of manufacturing the thin film magnetic head described in the embodiment but also to the case of manufacturing a sensor for sensing a magnetic signal (such as acceleration sensor), the cased of manufacturing a memory for storing a magnetic signal, and the like.

As described above, in the method of manufacturing a magnetoresistive device, the method of manufacturing a thin film magnetic head, and the method of manufacturing a head assembly according to the invention, the end face of the MR film is mechanically polished and, after that, subjected to wet etching. Consequently, residues of the mechanical polishing can be removed, and deterioration in the characteristics due to residues in the polishing process can be prevented. Damage to the MR film by the etching can be reduced, a step between the base and the MR film is smaller in comparison with the case of performing dry etching, and improved reproduction characteristics can be therefore achieved.

Particularly, in each of the method of manufacturing an MR device, the method of manufacturing a thin film magnetic head, and the method of manufacturing a head assembly according to one aspect of the invention, the step of forming the MR film includes the step of forming a first ferromagnetic layer, a tunnel barrier layer, and a second ferromagnetic layer in order on the base. Consequently, occurrence of an electric short circuit in the tunnel barrier layer due to residues in the polishing process can be prevented, and damage to the tunnel barrier layer by the etching can be reduced. Thus, a higher effect can be produced.

Each of the method of manufacturing a thin film magnetic head and the method of manufacturing a head assembly according to another aspect of the invention further includes a step of forming a recording head on the base before performing the mechanical polishing. Consequently, damage to the recording head by the etching can be also reduced, and a step in the recording head which is etched more easily as compared with the reproducing head can be made smaller than that in the case of performing dry etching. Thus, recording characteristics can be improved, and reproducing characteristics at the time of self recording can be further improved.

Obviously many modifications and variations of the present invention are possible in the light of the above teachings. It is therefore to be understood that within the scope of the appended claims, the invention may be practiced other wise than as specifically described.

What is claimed is:

1. A method of manufacturing a magnetoresistive device, comprising steps of:
forming a magnetoresistive film on a base; and
mechanically polishing an end face of the magnetoresistive film, and
performing wet etching on the end face mechanically polished.

2. A method of manufacturing a magnetoresistive device according to claim 1, wherein an etchant containing at least one of acid and alkali is used in the wet etching.

3. A method of manufacturing a magnetoresistive device according to claim 1, wherein the step of forming the magnetoresistive film includes a step of forming a first ferromagnetic layer, a tunnel barrier layer, and a second ferromagnetic layer in order on the base.

4. A method of manufacturing a magnetoresistive device according to claim 1, further comprising a step of forming a current path for passing a current in a direction perpendicular to an extending surface of the magnetoresistive film.

5. A method of manufacturing a thin film magnetic head comprising steps of:
forming a reproducing head having a magnetoresistive film on a base; and
mechanically polishing an end face of the magnetoresistive film, and
performing wet etching on the side face mechanically polished.

6. A method of manufacturing a thin film magnetic head according to claim 5, wherein an etchant containing at least one of acid and alkali is used in the wet etching.

7. A method of manufacturing a thin film magnetic head according to claim 5, wherein the step of forming the magnetoresistive film includes a step of forming a first ferromagnetic layer, a tunnel barrier layer, and a second ferromagnetic layer in order on a base.

8. A method of manufacturing a thin film magnetic head according to claim 5, wherein the step of forming the reproducing head includes a step of forming a current path for passing a current in a direction perpendicular to an extending surface of the magnetoresistive film.

9. A method of manufacturing a thin film magnetic head according to claim 5, further comprising a step of forming a recording head on the base before the step of mechanically polishing the end face.

10. A method of manufacturing a head assembly, comprising steps of:
forming a slider having a reproducing head; and
mounting the slider on a slider suspension, wherein the step of forming the slider comprises steps of:
forming a reproducing head having a magnetoresistive film on a base; and
mechanically polishing an end face of the magnetoresistive film, and
performing wet etching on the end face mechanically polished.

11. A method of manufacturing a head assembly according to claim 10, wherein an etchant containing at least one of acid and alkali is used in the wet etching.

12. A method of manufacturing a head assembly according to claim 10, wherein the step of forming the magnetoresistive film includes a step of forming a first ferromagnetic layer, a tunnel barrier layer, and a second ferromagnetic layer in order on the base.

13. A method of manufacturing a head assembly according to claim 10, wherein the step of forming the reproducing head includes a step of forming a current path for passing a current in a direction perpendicular to an extending surface of the magnetoresistive film.

14. A method of manufacturing a head assembly according to claim 10, further comprising a step of forming a recording head on the base before the step of mechanically polishing the end face.
